(19) United States
(12) Patent Application Publication
(10) Pub. No.: US 2015/0135092 A1
(43) Pub. Date: May 14, 2015

(54) APPARATUS AND METHOD FOR EXCHANGING DATA

(71) Applicant: ELECTRONICS AND TELECOMMUNICATIONS RESEARCH INSTITUTE, Daejeon (KR)

(72) Inventors: Joo-Young LEE, Daejeon (KR); Hyung-Kyu LEE, Daejeon (KR)

(73) Assignee: ELECTRONICS AND TELECOMMUNICATIONS RESEARCH INSTITUTE, Daejeon (KR)

(21) Appl. No.: 14/206,230

(22) Filed: Mar. 12, 2014

(30) Foreign Application Priority Data
Nov. 12, 2013 (KR) 10-2013-0137209

(51) Int. Cl. H04W 4/00; G06F 3/0484

(52) U.S. Cl. CPC H04W 4/005; H04W 4/008; G06F 3/0484
USPC 715/748; 455/41.2

(57) ABSTRACT

Provided are an apparatus and method for exchanging data. The data exchanging device includes an exchange data storage part configured to store exchange data acquired from a first terminal and transmitted to a second terminal, an exchange data communication part configured to connect communication to the first terminal or the second terminal, receive the exchange data from the first terminal and transmit the exchange data to the second terminal, and an exchange data control part configured to perform control to set the communication connection to the first terminal or the second terminal and send and receive the exchange data with the first terminal or the second terminal when a request for a communication connection from the first terminal or the second terminal is received as a copy function activation command is input to the first terminal or a paste function activation command is input to the second terminal.

### CROSS-REFERENCE TO RELATED APPLICATION

This application claims priority to and the benefit of Korean Patent Application No. 10-2013-0137209, filed on Nov. 12, 2013, the disclosure of which is incorporated herein by reference in its entirety.

### BACKGROUND

1. Field of the Invention

The present invention relates to an apparatus and method for exchanging data between terminals.

2. Discussion of Related Art

Recently, demands to exchange and share data between terminals are increasing rapidly. As one user uses multiple digital terminals, demands to use data which is generated and acquired from one terminal on other terminals or to send and receive data even between people are more frequent.

Typical methods for exchanging data between terminals are service-based methods, including methods using email, cloud services, various mobile applications (APP), and so on.

Methods using email are used universally in diverse information technology (IT) environments as well as smart terminals, and although there are weaknesses that the address of a communication partner must be acquired in advance and data cannot be transmitted in units of objects rather than files, it is useful when exchanging data with people located far away.

In the case of cloud services or web storages, usage of which has been increasing recently, because a service subscription is needed in advance and users must connect to the corresponding service in order to acquire data, it is mainly used for exchange of mass data and it is not suitable for simple exchange of data.

Currently, messengers and many other application programs for exchange of data are being provided among the application programs running on the terminals. In order to use these application programs, somewhat cumbersome procedures of installing the corresponding application program on the terminal by a user and setting a communication channel between two terminals, searching for data to be exchanged, selecting and attaching data to be exchanged, and so on are required.

Other methods for exchanging data between terminals include storage based methods, which typically include methods of using a Universal Serial Bus (USB) memory (USB flash drive), a USB external hard disk drive (Hard disk drive), etc. using a USB interface. Although a method for exchanging data using a USB is simple and commonly used, it has a disadvantage that it cannot be used on a terminal in which a USB interface is not provided. Particularly, because many recent smart terminals do not support USB interfaces, exchanging of data using USB memories is impossible.

There are also methods of using wireless storage on terminals, but in the case of smart terminals, in order to use wireless storage, a user must directly install an application program interworking with the wireless storage on the terminal and set communication for wireless communication. These processes are difficult to perform intuitively, and there is a disadvantage in that current wireless storages provide only fragmentary functions such as playing of data in the corresponding storage using smart terminals.

In addition, with regard to types of exchanged data, demands to edit link information such as a uniform resource locator (URL) generated in a terminal, or various content such as documents, pictures, videos, music, drawings, etc. as whole file or only part of a file and transmit the content to another terminal are increasing more and more. Since the typical methods for exchanging parts of content between terminals include editing the content, making the content into another file, and transmitting the file using a service based or storage based method for exchanging data, these methods can be inconvenient for many users.

Accordingly, in exchange of data between smart terminals, a means and method for alleviating the hassle of typical methods, getting rid of the file oriented methods for exchanging data, and exchanging through memories using data object oriented methods are required

With respect to background of the present invention, there is a patent application which relates to a method for providing a function using a touch pen of a mobile terminal device having a touch screen and a mobile terminal device implementing the same, and it is directed to performing a function according to information stored in the touch pen using a local area network between the body of the mobile terminal device and the touch pen.

### SUMMARY OF THE INVENTION

The present invention is directed to providing a data exchanging device and method for relaying data exchanging between terminals.

According to an aspect of the present invention, a data exchanging device having a touch input function is provided.

According to an embodiment of the present invention, the data exchanging device includes: an exchange data storage part configured to store exchange data acquired from a first terminal and transmitted to a second terminal; an exchange data communication part configured to connect communication to the first terminal or the second terminal, receive the exchange data from the first terminal and transmit the exchange data to the second terminal; and an exchange data control part configured to perform control to set the communication connection to the first terminal or the second terminal and send and receive the exchange data with the first terminal or the second terminal when a request for a communication connection from the first terminal or the second terminal is received as a copy function activation command is input to the first terminal or a paste function activation command is input to the second terminal.

Touch patterns corresponding to the copy function activation command and the paste function activation command may be set in the first terminal and the second terminal and a user may input the touch patterns to the first terminal and the second terminal using the touch input function.

The exchange data storage part may store data list information and manage a data list when the exchange data is a plurality of pieces of data.

The exchange data may be sent as a data stream without being converted to a file and the exchange data storage part may receive the data stream sequentially and store the data stream as a buffer.

The exchange data communication part may connect the communication to the first terminal or the second terminal using a local area network.

According to another aspect of the present invention, a data exchanging device having a touch input function is provided.

According to another embodiment of the present invention, the data exchanging device includes: an exchange data storage part configured to store exchange data acquired from a first terminal and transmitted to a second terminal; an exchange data communication part configured to connect communication to the first terminal or the second terminal, receive the exchange data from the first terminal and transmit the exchange data to the second terminal; an input part configured to receive a copy function activation command or a paste function activation command for the exchange data; and an exchange data control part configured to perform control to request a communication connection to the first terminal or the second terminal, set the communication connection to the first terminal or the second terminal and send and receive the exchange data with the first terminal or the second terminal when the copy function activation command or the paste function activation command is input.

The exchange data storage part may store data list information and manage a data list when the exchange data is a plurality of pieces of data.

The exchange data may be sent as a data stream without being converted to a file and the exchange data storage part may receive the data stream sequentially and store the data stream as a buffer.

The exchange data communication part may connect the communication to the first terminal or the second terminal using a local area network.

According to still another aspect of the present invention, a method for exchanging data between terminals performed by a data exchanging device having a touch input function is provided.

According to another embodiment of the present invention, the method for exchanging data includes: receiving a request for a communication connection from a first terminal and setting the communication connection to the first terminal as a selection input and a copy function activation command for exchange data stored in the first terminal are input to the first terminal; receiving and storing the exchange data from the first terminal; receiving a request for a communication connection from a second terminal and setting a communication connection to the second terminal as a paste location selection input and a paste function activation command for the exchange data are input to the second terminal; receiving a paste command from the second terminal; and extracting the exchange data and sending the exchange data to the second terminal in response to the paste command.

The receiving and storing of the exchange data from the first terminal may include storing data list information when the exchange data is a plurality of pieces of data, and after the paste command is received from the second terminal, the data list information may be sent to the second terminal and selection information for the exchange data selected by a user from the second terminal may be received.

According to yet another aspect of the present invention, a method for exchanging data between terminals performed by the exchanging device having a touch input function is provided.

According to another embodiment of the present invention, the method for exchanging data, including: receiving a copy function activation command through an input part as a selection input for exchange data stored in a first terminal is input to the first terminal; requesting a communication connection to the first terminal and setting the communication connection to the first terminal; sending a copy command to the first terminal; receiving and storing the exchange data from the first terminal; receiving a paste function activation command through the input part as a paste location selection input for the exchange data is input to a second terminal; requesting the communication connection to the second terminal and setting the communication connection to the second terminal; and extracting the exchange data and sending the exchange data to the second terminal.

The receiving and storing of the exchange data from the first terminal may include storing data list information when the exchange data is a plurality of pieces of data, and after the communication connection to the second terminal is set, the data list information may be sent to the second terminal, and selection information for the exchange data selected by a user from the second terminal may be received.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual view illustrating an example of data exchange between terminals performed by a data exchanging device;

FIG. 2 is a schematic diagram illustrating a configuration of a data exchanging device and a terminal;

FIG. 3 is a flowchart illustrating a method for copying data on a terminal and a data exchanging device;

FIG. 4 is a flowchart illustrating a method for pasting data on a terminal and a data exchanging device;

FIG. 5 is a flowchart illustrating a method for copying data on a terminal and a data exchanging device; and

FIG. 6 is a flowchart illustrating a method for pasting data on a terminal and a data exchanging device.

### DETAILED DESCRIPTION OF EXEMPLARY EMBODIMENTS

While the invention can be modified in various ways and take on various alternative forms, specific embodiments thereof are shown in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

When it is determined that detailed descriptions of related well-known technology might obscure the subject matter of the invention, those detailed descriptions will be omitted. In description of this specification, numbers (for example, the first, the second, etc.) are merely identifiers to distinguish one component from another.

It will be understood that when an element is referred to as being “connected” or “coupled” to another element, the element can be directly connected or coupled to another element or the element can be connected or coupled with another element intervening unless otherwise defined.

Hereinafter, exemplary embodiments of the invention will be described in detail with reference to the accompanying drawings. In order to facilitate overall understanding of the invention, like reference numerals denote like elements regardless of numerals in the drawings.

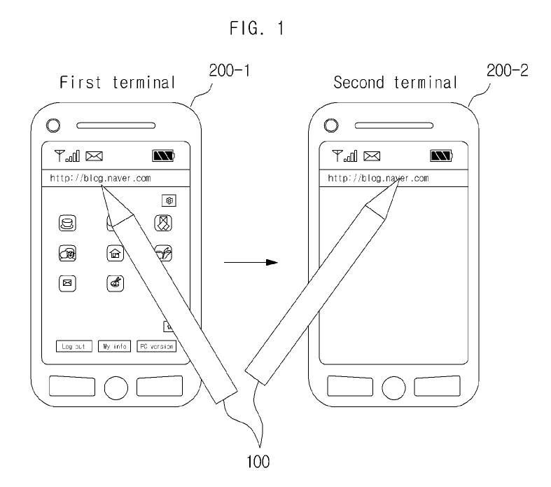

FIG. 1 is a conceptual view illustrating an example of data exchange between terminals performed by a data exchanging device.

Referring to FIG. 1, a data exchanging device 100 is a device having a touch input function through which a touch can be input to a terminal having a touch screen, as illustrated in FIG. 1, and may be formed as a touch pen. The data exchanging device 100 has a communication function of communicating with a first terminal 200-1 and a second terminal 200-2 and a storage function of storing data.

After copying and storing the data stored in the first terminal 200-1, the data exchanging device 100 may perform pasting on the second terminal 200-2. Herein, the data is various information processed in terminals, and may be, for example, files such as documents, drawings, pictures, videos, emails, databases, and so on, partial content in files (that is, data instances edited or selected by a user during execution of an application, such as partial melodies of music files, partial scenes of videos, parts of pictures, parts of documents being edited, etc.), link information, user input text, system information, metadata such as installation information of applications, etc.

For example, as illustrated in FIG. 1, when an application icon output on the touch screen of the first terminal 200-1 is selected through the touch input and a preset pattern corresponding to a copy command is input, the data exchanging device 100 may acquire and store the data of the corresponding application from the first terminal 200-1. Then, when the user selects a paste location on the touch screen of the second terminal 200-2 using the data exchanging device 100 and a preset pattern corresponding to a paste command is input, the data exchanging device 100 may transmit the stored data of the application to the second terminal 200-2 and the second terminal 200-2 may store the data of the application received from the data exchanging device 100.

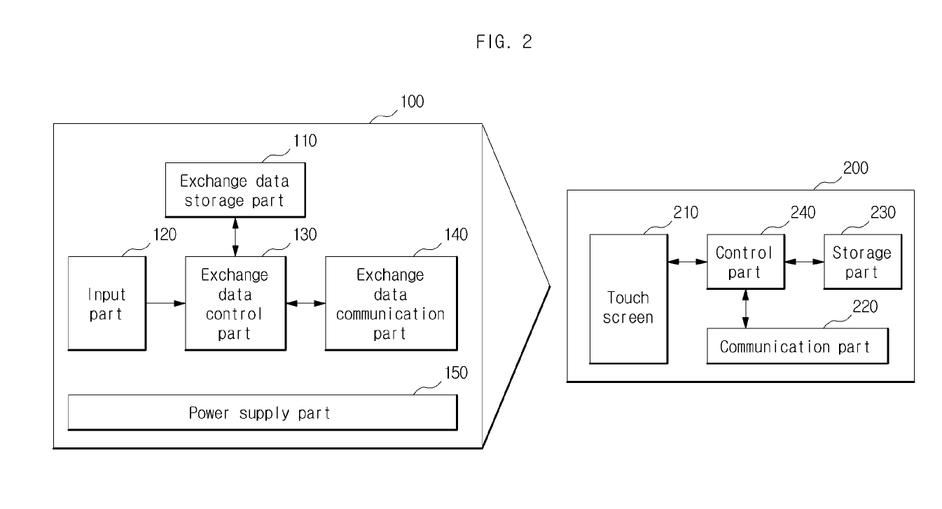

A method for exchanging data between terminals performed by the data exchanging device 100 and the data exchanging device 100 will be described below in detail with reference to FIGS. 2 to 6.

FIG. 2 is a schematic diagram illustrating a configuration of a data exchanging device and a terminal.

Referring to FIG. 2, a data exchanging device 100 includes an exchange data storage part 110, an input part 120, an exchange data control part 130, an exchange data communication part 140 and a power supply part 150, and a terminal 200 includes a touch screen 210, a communication part 220, a storage part 230, and a control part 240.

First, a configuration of the data exchanging device 100 will be described.

The exchange data storage part 110 stores data acquired from the terminal 200.

The exchange data input part 120 is as a user interface and receives a copy command or a paste command. For example, the exchange data input part 120 may be implemented if the copy command or the paste command is directly input to the data exchanging device 100 by the user, and when not implemented, a pattern corresponding to the copy command or the paste command is preset in the terminal 200 and the user may input the copy command or the paste command to the terminal 200 using the data exchanging device 100.

The exchange data communication part 140 connects communication to the terminal 200 and sends and receives data to and from the terminal 200. For example, the exchange data communication part 140 may include a local area network module, such as Bluetooth.

The exchange data control part 130 controls each component part of the data exchanging device 100 (for example, the exchange data storage part 110, the input part 120, the exchange data communication part 140, etc.) and performs copying and pasting of data in the terminal 200.

For example, when the user inputs an activation command (i.e. preset pattern) for the copy function or the paste function to the terminal 200 with respect to particular data of the terminal 200 using a touch input function of the data exchanging device 100, the terminal 200 requests a communication connection to the data exchanging device 100 and the exchange data control part 130 may control to connect the exchange data communication part 140 and the terminal 200 in response to the communication connection request. Then, when the exchange data control part 130 receives the data from the connected terminal 200 which is communication-connected, the exchange data control part 130 may control to store the received data in the exchange data storage part 110. The exchange data control part 130 may control to transmit the data stored in the exchange data storage part 110 to the communication-connected terminal 200.

The power supply part 150 supplies power to each component part of the data exchanging device 100 (for example, the exchange data storage part 110, the input part 120, the exchange data communication part 140, etc.).

Next, a configuration of the terminal 200 will be described.

The touch screen 210 is an input and output device of the terminal 200, outputs an image of the terminal 200, detects the touch input and outputs coordinates corresponding to a touched area to the control part 240.

The communication part 220 performs a wireless communication function between the terminal 200 and a wireless communication system or between the terminal 200 and another terminal. The terminal 200 may be a mobile communication terminal. In this case, the communication part 220 may include a mobile communication module. According to types of terminals, the communication part 220 may include communication devices, such as a local area network module, a wireless internet module, a broadcast receiving module, a Global Positioning System (GPS) receiving module, and so on.

Particularly, the communication part 220 connects a communication to the data exchanging device 100 and sends and receives data to and from the data exchanging device 100. For example, the communication part 220 may include the local area network module, such as Bluetooth.

The storage part 230 is used as a data storage of the terminal 200 and may include an internal storage module implemented by a random access memory (RAM), a synchronous dynamic RAM (SDRAM), a flash memory, etc. and an external storage module implemented by a Secure Digital (SD) card, a Universal Serial Bus (USB) memory, etc. Particularly, the storage part 230 may store the data received from the data exchanging device 100.

The control part 240 controls each component of the terminal 200 and an overall operation of the terminal 200.

Particularly, when an activation command (i.e. preset pattern) for the copy function or the paste function with respect to particular data is input to the control part 240 through the touch screen 210, the control part 240 controls the communication part 220 to communication-connect to the data exchanging device 100. Then, the control part 240 controls the communication part 220 and the storage part 230 to send and receive the data to and from the data exchanging device 100 in response to the activation command for the copy function or the paste function.

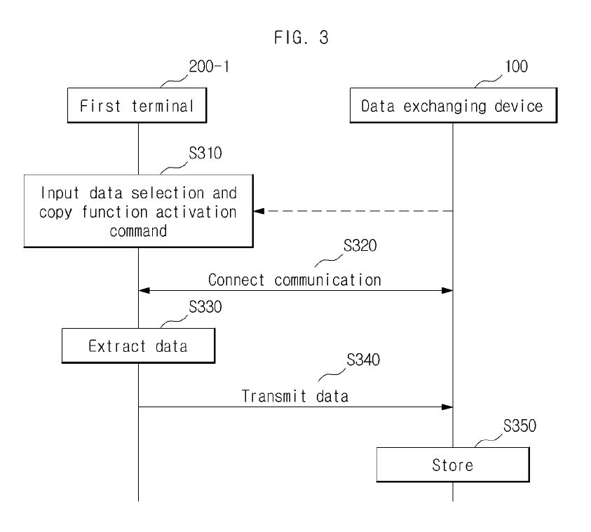

Next, a method for exchanging data in the data exchanging device 100 and the terminal 200 will be described with reference to FIGS. 3 to 6.

FIG. 3 is a flowchart illustrating a method for copying data in a terminal and a data exchanging device.

In operation S310, a data selection and a copy function activation command are input to a first terminal 200-1. For example, a user may select data to copy on a touch screen 210 of the first terminal 200-1 using a touch input function of a data exchanging device 100 and input a preset pattern corresponding to the copy function activation command through the touch screen 210 to the first terminal 200-1. Alternatively, the copy function activation command may be set in a menu or as an icon, or by pressing and holding the corresponding selection data.

In operation S320, the first terminal 200-1 connects communication with the data exchanging device 100 in response to the copy function activation command.

In operation S330, the first terminal 200-1 extracts the selected data in response to the copy function activation command from the storage part 230. For example, the first terminal 200-1 may read the corresponding data from the storage part 230 using data location information, such as a memory address and data length information. In this case, the attribute information or the metadata may be extracted together when there is attribute information or metadata related to the corresponding data.

In operation S340, the first terminal 200-1 transmits the extracted data to the data exchanging device 100. For example, the first terminal 200-1 may transmit the extracted data to the data exchanging device 100 as a data stream without converting the extracted data to a file.

In operation S350, the data exchanging device 100 stores the data received from the first terminal 200-1. For example, the data exchanging device 100 may store the received data as a buffer not having a particular file system in the exchange data storage part 110, and sequentially receive and store the data stream in the exchange data storage part 110. The data exchanging device 100 may manage a storage area starting address and length information of the stored data together, and when attribute information or metadata related to the corresponding data is received, the attribute information or the metadata may be managed together.

The data exchanging device 100 may store data list information in the exchange data storage part 110 and manage the data list when a plurality of pieces of data are received.

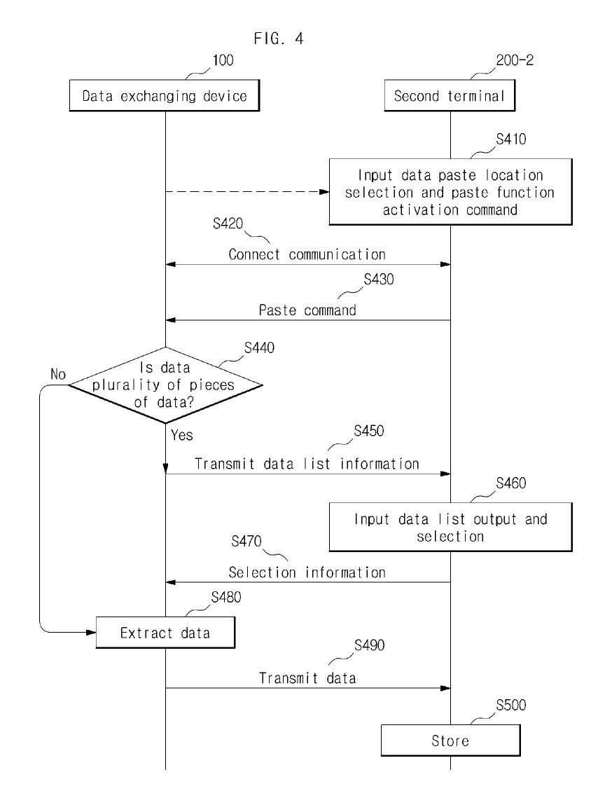

FIG. 4 is a flowchart illustrating a method for pasting data in a terminal and a data exchanging device.

In operation S410, a data paste location selection and a paste function activation command are input to a second terminal 200-2. For example, a user may select a location at which he or she wants to paste data on a touch screen 210 of the second terminal 200-2 using a touch input function of a data exchanging device 100 and input a preset pattern corresponding to a paste function activation command to the second terminal 200-2 through the touch screen 210. Alternatively, the paste function activation command may be set in a menu or as an icon, or by pressing and holding the relevant selection data.

In operation S420, the second terminal 200-2 connects communication with the data exchanging device 100 in response to the copy function activation command.

In operation S430, the second terminal 200-2 transmits the paste command to the data exchanging device 100 according to the communication connection with the data exchanging device 100.

In operation S440, the data exchanging device 100 checks whether the data stored in the exchange data storage part 110 in response to the paste command is a plurality of pieces of data. For example, the data exchanging device 100 may check whether the stored data is a plurality of pieces of data by checking data list information stored in the exchange data storage part 110.

In operation S450, the data exchanging device 100 transmits the data list information to the second terminal 200-2 when the stored data is a plurality of pieces of data.

In operation S460, the second terminal 200-2 outputs a data list according to the receipt of the data list information and receives a data selection input from the user.

In operation S470, the second terminal 200-2 transmits the selection information according to the data selection input to the data exchanging device 100.

In operation S480, the data exchanging device 100 extracts the data from the exchange data storage part 110. At this time, when there is attribute information or metadata related to the corresponding data, the data exchanging device 100 may extract the attribute information or the metadata together.

In operation S490, the data exchanging device 100 transmits the extracted data to the second terminal 200-2. For example, the data exchanging device 100 may transmit the extracted data as a data stream to the second terminal 200-2.

In operation S500, the second terminal 200-2 stores the data received from the data exchanging device 100. For example, the second terminal 200-2 may determine the attribute of the received data and store the received data in the storage area used by related programs (for example, operating systems, applications, etc.).

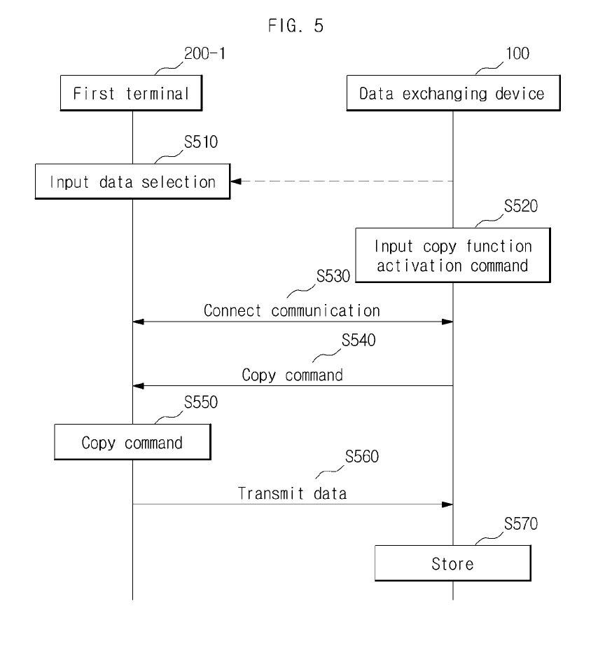

FIG. 5 is a flowchart illustrating a method for copying data in a terminal and a data exchanging device.

In operation S510, a first terminal 200-1 receives a data selection. For example, a user may select the data which he or she wants to copy on a touch screen 210 of the first terminal 200-1 using a touch pen function of a data exchanging device 100.

In operation S520, the data exchanging device 100 receives a copy function activation command according to the data selection. For example, the user may input the copy function activation command through an input part 120 of the data exchanging device 100.

In operation S530, the data exchanging device 100 connects communication with the first terminal 200-1 in response to the copy function activation command.

In operation S540, the data exchanging device 100 transmits the copy command to the first terminal 200-1 according to the communication connection with the first terminal 200-1.

In operation S550, the first terminal 200-1 extracts the selected data according to receipt of the copy command from the data exchanging device 100 from the storage part 230. For example, the first terminal 200-1 may read the corresponding data from the storage part 230 using data location information, such as a memory address and data length information. In this case, attribute information or metadata may be extracted together when there is attribute information or metadata related to the corresponding data.

In operation S560, the first terminal 200-1 transmits the extracted data to the data exchanging device 100. For example, the first terminal 200-1 may transmit the extracted data to the data exchanging device 100 as a data stream without converting the extracted data to a file.

In operation S570, the data exchanging device 100 stores the data received from the first terminal 200-1. For example, the data exchanging device 100 may store the received data as a buffer not having a particular file system in the exchange data storage part 110, and sequentially receive and store the data stream in the exchange data storage part 110. The data exchanging device 100 may manage a storage area starting address and length information of stored data together, and when the attribute information or the metadata related to the corresponding data is received, the attribute information or the metadata may be managed together.

The data exchanging device 100 may store data list information in the exchange data storage part 110 and manage the data list when a plurality of pieces of data are received.

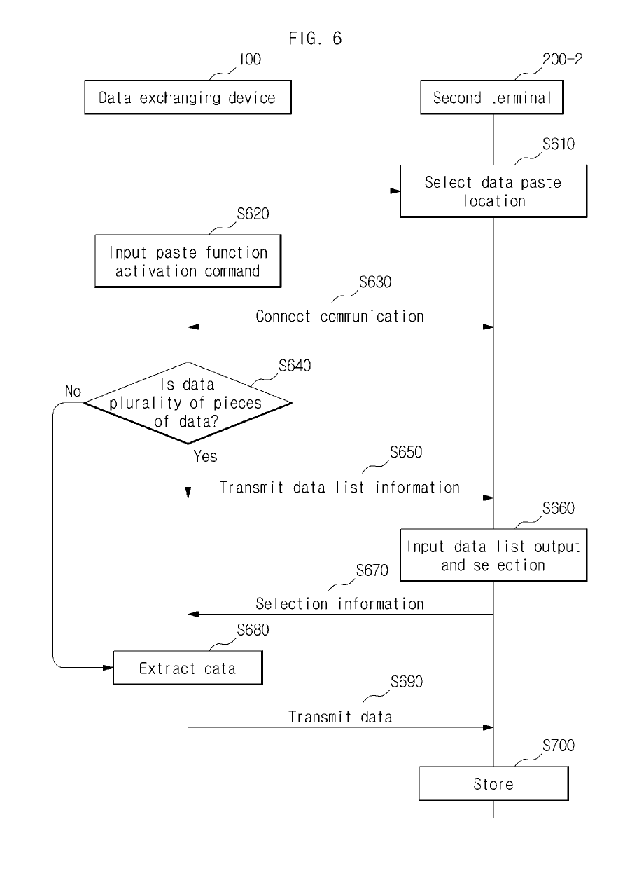

FIG. 6 is a flowchart illustrating a method for pasting data in a terminal and a data exchanging device.

In operation S610, a second terminal 200-2 receives a data paste location selection. For example, a user may select a location at which he or she wants to paste data on a touch screen 210 of the second terminal 200-2 using a touch pen function of a data exchanging device 100.

In operation S620, the data exchanging device 100 receives a paste function activation command according to the data paste location selection. For example, the user may input the paste function activation command through an input part 120 of the data exchanging device 100.

In operation S630, the data exchanging device 100 connects communication with the second terminal 200-2 in response to the paste function activation command.

In operation S640, the data exchanging device 100 checks whether the data stored in the exchange data storage part 110 in response to the paste function activation command is a plurality of pieces of data. For example, the data exchanging device 100 may check whether the stored data is a plurality of pieces of data by checking the data list information stored in the exchange data storage part 110.

In operation S650, the data exchanging device 100 transmits the data list information to the second terminal 200-2 when the stored data is a plurality of pieces of data.

In operation S660, the second terminal 200-2 outputs a data list according to receipt of the data list information and receives a data selection input from the user.

In operation S670, the second terminal 200-2 transmits the selection information according to the data selection input to the data exchanging device 100.

In operation S680, the data exchanging device 100 extracts the data from the exchange data storage part 110. In this case, the data exchanging device 100 may extract attribute information or metadata together when there is attribute information or metadata related to the corresponding data.

In operation S690, the data exchanging device 100 transmits the extracted data to the second terminal 200-2. For example, the data exchanging device 100 may transmit the extracted data as a data stream to the second terminal 200-2.

In operation S700, the second terminal 200-2 stores the data received from the data exchanging device 100. For example, the second terminal 200-2 may determine the attribute of the received data and store the received data in the storage area used by related programs (for example, operating systems, applications, etc.).

According to the present invention, a data exchanging device can mediate the exchange of data between terminals.

While the example embodiments of the present invention and their advantages have been described in detail, it should be understood by those of skilled in the art that various changes, substitutions and alterations may be made herein without departing from the scope of the invention as defined by the following claims.

What is claimed is:

1. A data exchanging device having a touch input function, comprising:
an exchange data storage part configured to store exchange data acquired from a first terminal and transmitted to a second terminal;
an exchange data communication part configured to connect communication to the first terminal or the second terminal, receive the exchange data from the first terminal and transmit the exchange data to the second terminal; and
an exchange data control part configured to perform control to set the communication connection to the first terminal or the second terminal and send and receive the exchange data with the first terminal or the second terminal when a request for a communication connection from the first terminal or the second terminal is received as a copy function activation command is input to the first terminal or a paste function activation command is input to the second terminal.

2. The data exchanging device of claim 1, wherein touch patterns corresponding to the copy function activation command and the paste function activation command are set on the first terminal and the second terminal, and a user inputs the touch patterns to the first terminal and the second terminal using the touch input function.

3. The data exchanging device of claim 1, wherein the exchange data storage part stores data list information and manages a data list when the exchange data is a plurality of pieces of data.

4. The data exchanging device of claim 1, wherein the exchange data is sent as a data stream without being converted to a file and the exchange data storage part receives the data stream sequentially and stores the data stream as a buffer.

5. The data exchanging device of claim 1, wherein the exchange data communication part connects the communication to the first terminal or the second terminal using a local area network.

6. A data exchanging device having a touch input function, comprising:
an exchange data storage part configured to store exchange data acquired from a first terminal and transmitted to a second terminal;
an exchange data communication part configured to connect communication to the first terminal or the second terminal, receive the exchange data from the first terminal and transmit the exchange data to the second terminal;
an input part configured to receive a copy function activation command or a paste function activation command for the exchange data; and
an exchange data control part configured to perform control to request a communication connection to the first terminal or the second terminal, set the communication connection to the first terminal or the second terminal and send and receive the exchange data with the first terminal or the second terminal when the copy function activation command or the paste function activation command is input.

7. The data exchanging device of claim 6, wherein the exchange data storage part stores data list information and manages a data list when the exchange data is a plurality of pieces of data.

8. The data exchanging device of claim 6, wherein the exchange data is sent as a data stream without being converted to a file and the exchange data storage part receives the data stream sequentially and stores the data stream as a buffer.

9. The data exchanging device of claim 6, wherein the exchange data communication part connects the communication to the first terminal or the second terminal using a local area network.

10. A method for exchanging data between terminals performed by a data exchanging device having a touch input function, comprising:
receiving a request for a communication connection from a first terminal and setting the communication connection to the first terminal as a selection input and a copy function activation command for exchange data stored in the first terminal are input to the first terminal;
receiving and storing the exchange data from the first terminal;
receiving a request for a communication connection from a second terminal and setting the communication connection to the second terminal as a paste location selection input and a paste function activation command for the exchange data are input to the second terminal;
receiving a paste command from the second terminal; and
extracting the exchange data and sending the exchange data to the second terminal in response to the paste command.

11. The method of claim 10, wherein the receiving and storing of the exchange data from the first terminal comprises:
storing data list information when the exchange data is a plurality of pieces of data,
and further comprising, after receiving the paste command from the second terminal:
sending the data list information to the second terminal; and
receiving selection information for the exchange data selected by a user from the second terminal.

12. A method for exchanging data between terminals performed by a data exchanging device having a touch input function, comprising:
receiving a copy function activation command through an input part as a selection input for exchange data stored in a first terminal is input to the first terminal;
requesting a communication connection to the first terminal and setting the communication connection to the first terminal;
sending a copy command to the first terminal;
receiving and storing the exchange data from the first terminal;
receiving a paste function activation command through the input part as a paste location selection input for the exchange data is input to a second terminal;
requesting the communication connection to the second terminal and setting the communication connection to the second terminal; and
extracting the exchange data and sending the exchange data to the second terminal.

13. The method of claim 12, wherein the receiving and storing of the exchange data from the first terminal comprises:
storing data list information when the exchange data is a plurality of pieces of data,
and further comprising, after setting the communication connection to the second terminal:
sending the data list information to the second terminal; and
receiving selection information for the exchange data selected by a user from the second terminal.
